(19) United States
(12) Patent Application Publication
(10) Pub. No.: US 2003/0061013 A1
(43) Pub. Date: Mar. 27, 2003

(54) Optimal selection of IP modules for design integration

(76) Inventor: William F. Bentley, New Boston, NH (US)

Correspondence Address: Anthony T. Cascio, BURNS, DOANE, SWECKER & MATHIS, L.L.P., P.O. Box 1404, Alexandria, VA, 22313-1404, US

(21) Appl. No.: 09/953,347

(22) Filed: Sep. 11, 2001

(51) Int. Cl. G06F 17/10

(52) U.S. Cl. 703/2

(57) ABSTRACT

Modules obtainable from a plurality of intellectual property sources are integrated into a single design. One of the integration environments for the design is first selected and available ones of the modules within the selected integration environment are also selected. Other modules from other integration environments in the event all of the modules to be integrated into the design are not present in the selected one of the integration environments are next selected. An integration coefficient is calculated as a function of a number of integration environments from which all of the selected modules have been selected and a number of modules.

### BACKGROUND OF THE INVENTION

1. Field of the Invention

The present invention relates generally to selection of intellectual property modules to be integrated into a single design, and, more particularly, to apparatus and methods practiced in conjunction with an integration environment to determine a relative ease of integration of a collection of the modules into the integration environment and a relative compatibility of each of the modules to each other.

2. Description of the Related Art

In the design of processes, machines and articles of manufacture, one skilled in the art typically constructs such design as a combination of known processes or functional modules, which may collectively be referred to herein as intellectual property modules. For example, a complex design may first be defined by a plurality of functional subparts that interact within the design to produce the desired end result of the design. Secondly, a search may then be performed for one or more sources of known intellectual property modules that perform the function of each respective one of the subparts. Ideally, when these known modules are assembled and interconnected in accordance with the design, the desired end result of the design should be obtained.

However, it is well known that, when obtaining such functional modules from different sources, a module from one such source may be incompatible with a module from another such source. It is also well known that modules obtainable from a single source may also be incompatible with each other because of version and revision level differences. The resultant high probability of incompatibility between two or more modules in the design may disadvantageously degrade or limit the desired functional end result of the design. Furthermore, the design process may also be disadvantageously lengthened or result in increased effort to accomplish the design.

For example, a skilled artisan may, in constructing a specific design, utilize a workstation programmed with computer aided design (CAD) software commercially available from a specific vendor. The CAD software may contain a library of known modules. However, the design itself may call for one or more modules not contained in the library. The artisan must then locate such modules from other sources, such as libraries in other CAD software. Accordingly, the artisan then may have the task of integrating these externally located modules into the library of the currently utilized CAD software. A disadvantage and limitation of this approach to integration is that the artisan, other than through past experience with the same or similar modules, has no objective assessment of the relative ease or difficulty that such externally located modules may be integrated into the current library.

Similarly, catalogs of IP modules exist wherein such IP modules are sortable by function, supplier, and the case of integrated circuit modules, clock rate, process and type. For example, the artisan may access such catalog and display all available modules by function. The artisan may then choose the modules desired and drag and drop each of the modules into a pallet window. Alternatively, the artist and may display all such modules by supplier and choose the necessary modules from a desired supplier and if all such modules are not provided by such supplier choose the remaining modules from one or more different suppliers. In choosing modules, each of the chosen modules is again dragged and dropped into the pallet.

In a specific example, the designer may need to choose a particular IP module for system on chip (SOC) integration. The designer may be working within an integration environment wherein IP modules within the system communicate with a controller along a separate channel unique to each module. However, the designer may be unsuccessful in locating a particular module for a required function in the proposed design. The designer may find a module performing the requisite function within another integration environment wherein such modules communicate along a time multiplex bus.

The difference between two modules is that, for the channel communication environment, the module will have a channel manager, whereas for the multiplexed bus environment, the module will have an interrupt and acknowledge input. Moreover, the pin assignments for the module in the multiplexed bus environment do not readily allow for this module to be used in the channel communication environment for which it was not designed. However, the module for the multiplexed bus environment may be modified to work in the channel communication environment.

For example, the skilled artisan may know of additional devices that adapt the to work within the channel communication environment. Additionally, there may exist application notes or other technical data sheets that describe possible adaptations of the module for the multiplexed bus environment to the channel communication environment. However, neither personal knowledge, application notes nor technical data sheets provide to the skilled artisan an objective assessment of the relative ease or difficulty of the required adaptation.

Accordingly, it is highly desirous to provide methods and apparatus which would enable a skilled artisan to objectively assess the relative ease or difficulty that such externally located modules may be integrated into the current integration environment. It is also highly desirous to provide a method and apparatus which would allow searching to be performed for modules which, when integrated, obviate or at least minimize the probability of incompatibility between such modules.

### SUMMARY OF THE INVENTION

It is an object of the present invention to overcome one or more disadvantages and limitations of the prior art above enumerated.

According to the present invention, a method for integrating modules obtainable from a plurality of intellectual property sources into a single design comprises selecting one of the integration environments for the design, selecting for the design available ones of the modules within the selected one of the integration environments, selecting for the design other ones of the modules from other ones of the integration environments in the event all of the modules to be integrated into the design are not present in the selected one of the integration environments, and computing an integration coefficient as a function of a number of integration environments from which all of the selected modules have been selected and the number of selected modules. The integration coefficient for a pallet may also be a function of compatibility coefficients referred to below.

A feature of the above method of the present invention is that each of the modules not within the integration environment may be assigned a compatibility coefficient prior to selecting such modules. The skilled artisan would then normally choose for the pallet those modules having a compatibility coefficient indicating a relatively higher degree of compatibility than another module providing the substantially identical function with a relatively lower degree of compatibility. The skilled artisan could also rely in the selection process on extraneous information, such as information known to the artisan through prior experience allowing rejection of a module with the higher degree of compatibility in favor of the module with the lower degree of compatibility.

Another feature of the present invention is that an integration coefficient for the pallet may also be computed as a function of the compatibility coefficient for each of the modules chosen external of the integration environment and a total number of the modules used within said pallet. This computation may be performed using several different algorithms based, for example, on combinatorial, geometric or arithmetic functions. The skilled artisan may further computer several different integration coefficients for the design based on substitution of modules to determine the best overall integration coefficient.

These and other objects, advantages and features of the present invention will become readily apparent to those skilled in the art from a study of the following description of the exemplary Preferred Embodiments when read in conjunction with the attached Drawing and Appended claims.

### BRIEF DESCRIPTION OF THE DRAWING

FIG. 1 is a flowchart useful to describe one embodiment of the present invention;

FIG. 2 is a flowchart useful to describe another embodiment of the present invention;

FIG. 3 is a flowchart illustrating in greater detail one step of the flowchart of FIG. 1 or FIG. 2; and

FIG. 4 is a block diagram of an apparatus useful to practice the present invention.

### DESCRIPTION OF THE EXEMPLARY PREFERRED EMBODIMENTS

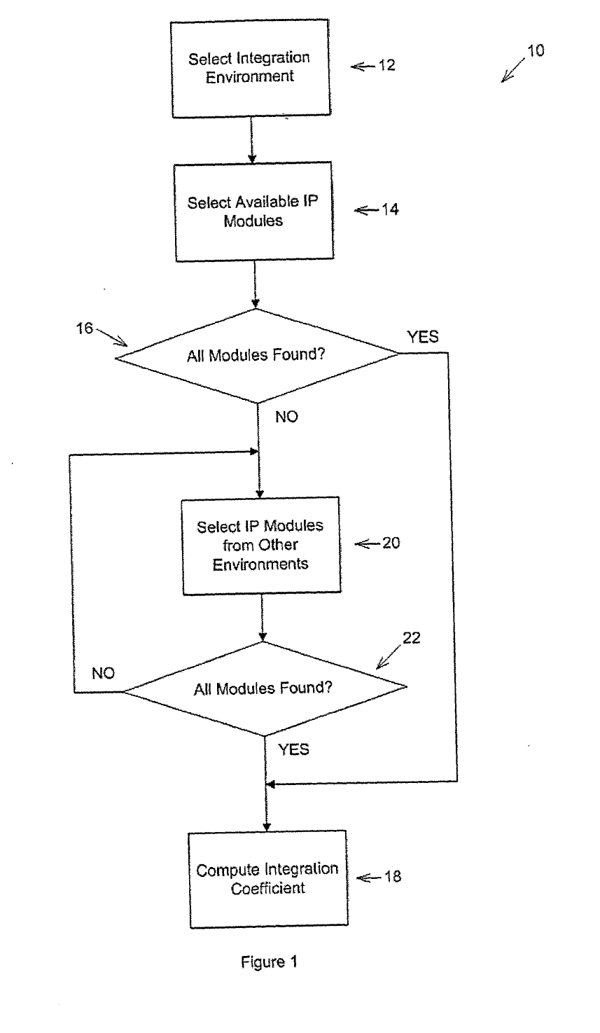

Referring now to FIG. 1, there is shown a flowchart 10 useful to describe one embodiment of the present invention in which a relative ease of integrating intellectual property modules obtainable from a plurality of integration environment into a single design is determined. As indicated at step 12, one of the integration environments for the design is selected. Next, as indicated at step 14, available ones of the intellectual property modules within the selected integration environment are selected.

As indicated at step 16, a decision is made to determine whether all the intellectual property modules required for the design have been found within the integration environment. If yes, a path is taken to step 18 wherein an integration coefficient of relatively easily integration is computed, as herein below described. If no, a path is taken to step 20 where at other intellectual property modules from other integration environments are selected. As indicated at step 22, a decision is made once again to determine if all modules are found. If no, the process returns to step 20 wherein further IP modules from other integration environments are selected. If yes, the path is taken to step 18 wherein the integration coefficient is computed.

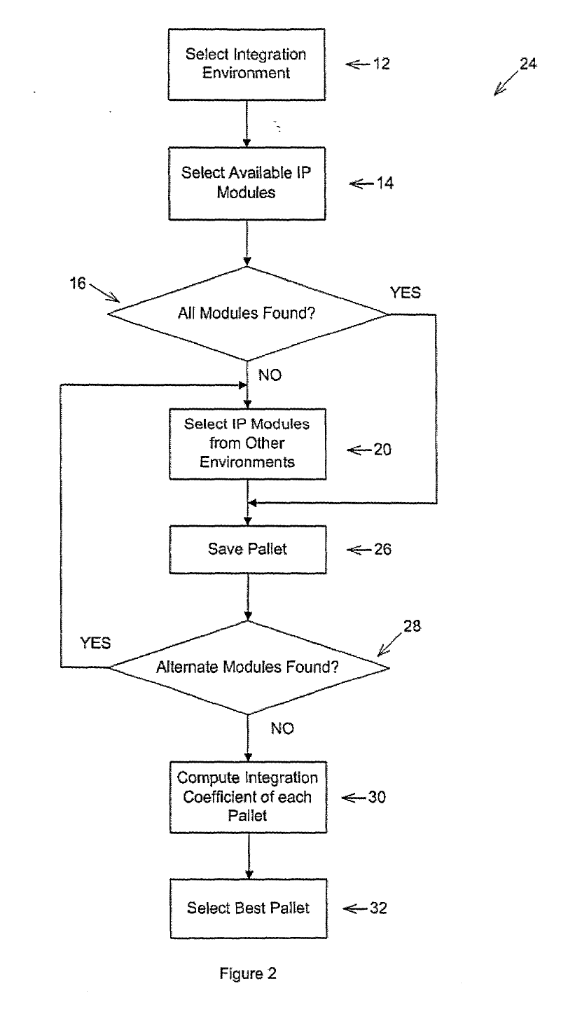

Referring now to FIG. 2, there is shown the flowchart 24 useful describes another embodiment of the present invention. Similarly as described above, an integration environment is selected as indicated at step 12, available intellectual property modules are selected as indicated at step 14, a decision is made at step 16 to determine if all modules are found, and if no, selection of other intellectual property modules from other integration environments is made at step 20.

Once the modules from other environments have been selected, as indicated at step 20, or all modules have been found that can be found, as indicated that step 16, the collection of intellectual property modules in the selected integration environment is saved as a pallet, as indicated at step 26. Thereafter, a decision may be made, as indicated at step 28 whether alternative intellectual property modules exist which may also be included within the design. If yes, the above described steps 20 and 26 are repeated such that after each selection a new pallet is saved.

After all alternatives have been exhausted at step 28, a path is taken to step 30 wherein the integration coefficient for each pallet is computed. Upon computing the integration coefficient for each pallet, a path is taken to step 32 where the best pallet, as indicated by the best integration coefficient, is selected.

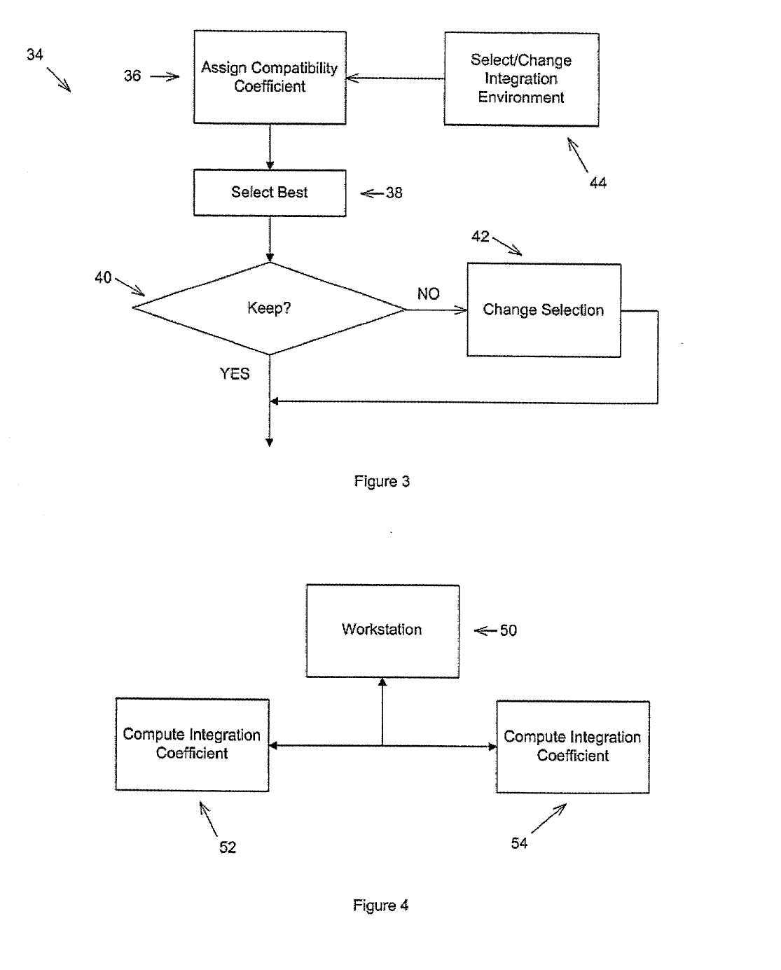

With reference to FIG. 3, there is shown a flowchart 34 useful to describe one exemplary embodiment of the selecting step 20. Each intellectual property module may be assigned a compatibility coefficient which relates to its ease of integration into the selected integration environment, as indicated at step 36. For example, a desired function may be met by several different intellectual property modules, wherein each of these modules is designed for different integration environment. Certain ones of these modules may be easier to integrate into the current integration environment than others.

Accordingly, at step 38, it is indicated that the intellectual property modules with the best compatibility coefficient are selected. However, decision may be made, as indicated at step 40 whether to keep the selected modules. If no, a path is taken to step 42 where the selection may be changed. For example, in the experience of the user, a module having a lower compatibility coefficient may actually be preferable as determined from predetermined criteria or for extraneous reasons. Otherwise, the yes path is taken to return to the process of either FIG. 1 or FIG. 2.

The process of the flowchart 34 may also be repeated by selecting or changing the integration environment, as indicated at step 44. With this step, several pallets may be compared using different integration environments in the process of FIG. 2.

With reference to FIG. 4, there is shown a workstation 50, the computer readable medium 52 and the database 54. The computer readable medium 52 may contain executable code which when executed by the workstation 50 implements the methods of the invention described herein. Accordingly, the computer readable medium 52 may be any disk storage device, or memory internal to the workstation 50, or external thereto either stand-alone or on a public or private computer network (not shown). The database 54 contains the readable data for the integration environments and each of the intellectual property modules. Similarly, the database may be stored within the workstation 50 or be external thereto and accessible through a public or private computer network.

The integration coefficient computing step 18, 30 may include first computing an estimate of the relative degree of ease of integration. The estimate may first be computed as a combinatorial algorithm. An exemplary combinatorial algorithm may be expressed as 1/V(V-1), wherein V is equal to the number of integration environments.

Alternatively, the estimate may be computed as a geometric algorithm. An exemplary geometric algorithm may be expressed as e/eˆ (V−1), wherein V is equal to the number of integration environments.

In yet another alternative embodiment, the estimate may be computed as an arithmetic algorithm. An exemplary arithmetic algorithm may be expressed as 1−((V−1)/maxV), wherein V is equal to the number of integration environments.

Generally, the integration coefficient is further a function of the number of integration environments and a number of the modules in each respective one of the number of integration environments.

The integration coefficient may be a further a function of a proportion of the modules in the other ones of the integration environments to all of the modules in the pallet. The integration coefficient may also be a further a function of a presence of specific ones of the integration environments and a number of the modules in each respective one of the specific ones of integration environments.

In one embodiment of the present invention, the integration coefficient, W( ), may be expressed as a first function, f( ), of the number of integration environments and a number of the modules in each respective one of the number of integration environments, In another embodiment the integration coefficient, W( ), may be expressed as a second function, g( ), of a proportion of the modules in the other ones of the integration environments to all of the modules in the pallet. The integration coefficient, W( ), may also be expressed as a third function, h( ), of a presence of specific ones of the integration environments and a number of the modules in each respective one of the specific ones of integration environments. These functions may also be used in any combination with each other.

More particularly, the first function may be expressed as f( )=f(V,∃Pn,Pn, % Pn,P[x], % P[x]), the second function may be expressed as g( )=g(Pn, % Pn), and the third function may be expressed as h( )=h(P[xy],P[x], % P[x]).

The symbols in the above defined equations may be defined as:

P=number of IP modules present in the collection

Px=number of IP modules present in the collection targeted for IP integration environment “x”

P[x] represents the group of all such variables Px

Pn=number of IP modules present in the collection not targeted for any IP integration environment

V=the total number of IP integration environments present in the collection; i.e. the total number of non-zero P(x) NOT counting P(n)

% Px=Px/P

% P[x] represents the group of all such variables % Px

% Pn=Pn/P

For example, if a collection of IP contains:

3 items targeted for integration environment “a”

4 items target for integration environment “b”

2 items targeted for integration environment “c”

3 items not targeted for any integration environment

| | |
|---|---|
| P = 12 | V = 3 |
| Pa = 3 | % Pa = 25% |
| Pb = 4 | % Pb = 33 ⅓^{rd}% |
| Pc = 2 | % Pc = 16 ⅔^{rd}% |
| Pd = 0 | % Pd = 0% |
| Pn = 3 | % Pn = 25% |

[x] represents the group of variables Pa, Pb, Pc, Pd

% P[x] represents the group of variables % Pa, % Pb, % Pc, % Pd

Pxy is a logical ‘existence’ variable whose value is 1 or TRUE if items exist in the collection from both integration environment ‘x’ environment ‘y’ and 0 or FALSE if items targeted for both integration environments are not present in the collection. That is:

Pxy=(Px<>0) AND (Py<>0)

P[xy] represents the group of all such variables Pxy

In the example above, the variables

Pab Pac Pan

Pbc Pbn Pcn

are all TRUE (or 1)

Pad Pbd Pcd Pnd

are all FALSE (or 0)

P[xy] represents the group of variables Pab, Pac, Pad, Pan, Pbc, Pbd, Pbn, Pcd, Pcn, Pdn

∃Pn is a logical existence variable that is 1 or TRUE if Pn<>0 and 0 or FALSE if Pn=0.

The computing step 18, 30 may further include scaling the integration coefficient in the event all of the modules in the pallet are selected from only one of the integration environments. The scaling may include a scaling factor, M, such that W( )=M*W( ). Exemplarily, the scaling factor is expressed as M=Σ(M[x]*% P[x]). The scaling factor may also be different for each respective one of the integration environments.

The arithmetic form of f( ) may be expressed as f(V)=(S+1−V)/S, wherein S is the total number of integration environments in the collection. Homogeneous collections will equal 1 whereas nonhomogeneous collections will vary with S. Note that f(V)=(S−V)/S may also be used, but the first arithmetic form of f( ) is preferred.

The geometric form of f( ) may be expressed as f(V)=1/(kˆ (j*(V−1))), wherein j and k are constants. It is apparent that this function is independent of the number of integration environments in the collection. For a homogenous collection, this geometric form will compute to unity. This allows all of the differences in integration effort required between different=integration environments to be reflected in the scaling factor M as described above. The constants j and k parameterize the equation to allow the regulation of the shape of the curve to reflect engineering judgments about how much more difficult multiple integration environments are to integrate then and environment with less integration environments.

The combinatorial form of f( ) may be expressed as f(V)=1/k(V*(V−1)). IF all Pn are considered to constitute one new integration environment, then f(V,∃Pn)=1/k(V+∃Pn)*(V+∃Pn−1)). The equation can also be combined with the function g( ) that at a scalable factor for consideration of the absolute number of untargeted modules in the collection. Alternatively, g( ) can be combined with f( ) if each untargeted module constitutes a new integration environment, wherein f(V,Pn)=1/k(V+Pn)*(V+Pn−1)).

The arithmetic form of g( ) may be expressed as g( )=q % Pn, wherein q is a constant. The simplicity of this form is apparent and does not require further explanation.

The geometric form of g( ) may be expressed as 1−(1/(sˆ (t*% Pn))), wherein s and t are constants. The constants parameterize the form of the curve. For example, values of s=2 and t=1 scaled calculation such that a collection of modules composed entirely of modules not targeted for any defined integration environment receives a score half that of a homogenous collection. It also expresses a more accurate, nonlinear relationship between the amount of effort required. This form of g( ) is probably best the use in combination with a function f( ) that assumes a nonzero Pn constitutes one additional integration environment to the collection or that takes no consideration of a Pn in f( ).

The combinatorial form of g( ) is covered by a combined arithmetic and geometric g( ) if each Pn constitutes a new integration environment. If it is desired to scale the effect of the combinatorial total of Pn differently than V, then f( )=1/k₁(V*V−1) should be multiplied by g( )=1/k₂(Pn*Pn−1)). The selection of k₁ and k₂ will require a different strategy and assumption that the selection of a single scaling constant k.

Regarding the function ho, the effort required to combine intellectual property targeted for two different integration environments can be separated into a constant portion, required if only one module from each environment is present in the collection, and a variable portion that is a function of the amount of intellectual property from each environment present. Terms can be added that reflect the contribution of each environment x and y on their own rather than their product.

This can in one embodiment of the invention be represented by If(Pxy=TRUE, (Cxyc+Cxyp % Px % Py+Cxyx % Px+Cxyy % PY),else 1), where Cxyx is a constant representing the fixed integration overhead andcxyp, Cxyx and Cxyy are constants representing the proportional integration effort required of the combined and individual integration environments via their proportion, respectively. In order to calculate the effects of all combinations of integration environments in the collection, list of these factors must be calculated solute or factor together.

The methods of the present application may be practiced in accordance with a website, or other private or public network, or on an appropriately programmed workstation. Such apparatus is described in U.S. patent application, Ser. No. 09___,___, filed on even date herewith.

There has been described hereinabove novel apparatus and methods for determining the relative ease of integration of intellectual property modules into a design using a selected integration environment. Those skilled in the art may now make numerous uses of and departures from the above descried exemplary embodiments without departing from the novel concepts and principles of the present invention. Accordingly, the present invention is to be defined solely by the permissible scope of the appended claims.

What is claimed as the invention is:

1. A method for determining a relative ease of integrating intellectual property modules designed for a plurality of integration environments into a single design comprising steps of:
selecting one of said integration environments for said design;
selecting for said design available ones of said modules within said one of said integration environments;
selecting for said design other ones of said modules from other ones of said integration environments in the event all of said modules to be integrated into said design are not present in said one of said integration environments; and
computing an integration coefficient of relative ease of integration as a function of the number of integration environments from which all of said selected modules have been selected and the number of modules selected.

2. A method a set forth in claim 1 further comprising:
repeating said selecting other ones of said modules such that a pallet is defined after each repeating;
computing said integration coefficient for each pallet; and
selecting one pallet for which said integration coefficient indicates a relatively higher degree of ease of integration from each other pallet.

3. A method as set forth in claim 1 further comprising associating a compatibility coefficient of compatibility to said one of said integration environments for each of said modules from said other ones of said integration environments prior to said selecting of said other ones of said modules.

4. A method as set forth in claim 3 wherein said modules selected from said other ones of said integration environments with said compatibility coefficient indicates a greater degree of compatibility are first selected.

5. A method as set forth in claim 4 wherein said modules selected from said other ones of said integration environments with said compatibility coefficient indicating a lesser degree of compatibility are first selected in accordance with predetermined criteria in lieu of said modules with said compatibility coefficient indicating said greater degree of compatibility.

6. A method as set forth in claim 3 wherein said integration coefficient is computed further as a function of said compatibility coefficient for each of said modules from said other ones of said integration environments within each pallet.

7. A method as set forth in claim 1 wherein said computing includes first computing an estimate of said relative degree of ease of integration.

8. A method as set forth in claim 7 wherein said computing said estimate is computed as a combinatorial algorithm.

9. A method as set forth in claim 8 wherein said combinatorial algorithm is expressed as 1/V(V−1), wherein V is equal to said number of integration environments.

10. A method as set forth in claim 7 wherein said computing said estimate is computed as a geometric algorithm.

11. A method as set forth in claim 10 wherein said geometric algorithm is expressed as e/eˆ (V−1), wherein V is equal to said number of integration environments.

12. A method as set forth in claim 7 wherein said computing said estimate is computed as an arithmetic algorithm.

13. A method as set forth in claim 12 wherein said combinatorial algorithm is expressed as 1−((V−1)/maxV), wherein V is equal to said number of integration environments.

14. A method as set forth in claim 1 wherein said integration coefficient is further a function of said number of integration environments and a number of said modules in each respective one of said number of integration environments.

15. A method as set forth in claim 1 wherein said integration coefficient is further a function of a proportion of said modules in said other ones of said integration environments to all of said modules in said pallet.

16. A method as set forth in claim 1 wherein said integration coefficient is further a function of a presence of specific ones of said integration environments and a number of said modules in each respective one of said specific ones of integration environments.

17. A method as set forth in claim 1 wherein said integration coefficient, W( ), is further a function of s elected ones of a first function, f( ), of said number of integration environments and a number of said modules in each respective one of said number of integration environments, a second function, g( ), of a proportion of said modules in said other ones of said integration environments to all of said modules in said pallet, and a third function, h( ), of a presence of specific ones of said integration environments and a number of said modules in each respective one of said specific ones of integration environments.

18. A method as set forth in claim 17 wherein said first function is expressed as f( )=f(V,∃Pn,Pn, % Pn,P[x], % P[x]).

19. A method as set forth in claim 17 wherein said second function is expressed as g( )=g(Pn, % Pn).

20. A method as set forth in claim 17 wherein said third function is expressed as h( )=h(P[xy],P[x], % P[x]).

21. A method as set forth in claim 1 wherein computing further includes scaling said integration coefficient in the event all of said modules in said pallet are selected from only one of said integration environments.

22. A method as set forth in claim 21 wherein said scaling includes a scaling factor, M, such that W( )=M*W( ).

23. A method as set forth in claim 22 wherein said scaling factor is expressed as M=∃(M[x]*% P[x]).

24. A method as set forth in claim 23 wherein said scaling factor is different for each respective one of said integration environments.

25. A computer readable medium containing program code for determining a relative ease of integrating intellectual property modules obtainable from a plurality of integration environments into a single design that when executed implements procedures of:
selecting one of said integration environments for said design;
selecting for said design available ones of said modules within said one of said integration environments;
selecting for said design other ones of said modules from other ones of said integration environments in the event all of said modules to be integrated into said design are not present in said one of said integration environments, all of said selected modules defining a pallet; and
computing an integration coefficient of relative ease of integration for each pallet as a function of the number of integration environments from which all of said selected modules have been selected and the number of modules in each pallet.

26. A medium a set forth in claim 25 further comprising:
repeating said selecting other ones of said modules such that a further pallet is defined after each repeating;
computing said integration coefficient for each pallet; and
selecting one pallet for which said integration coefficient indicates a relatively higher degree of ease of integration from each other pallet.

27. A medium as set forth in claim 25 further comprising associating a coefficient of compatibility to said one of said integration environments for each of said modules from said other ones of said integration environments prior to said selecting of said other ones of said modules.

28. A medium as set forth in claim 27 wherein said modules selected from said other ones of said integration environments with said compatibility coefficient indicates a greater degree of compatibility are first selected.

29. A medium as set forth in claim 28 wherein said modules selected from said other ones of said integration environments with said compatibility coefficient indicating a lesser degree of compatibility are first selected in accordance with predetermined criteria in lieu of said modules with said compatibility coefficient indicating said greater degree of compatibility.

30. A medium as set forth in claim 27 wherein said integration coefficient is computed further as a function of said compatibility coefficient for each of said modules from said other ones of said integration environments within each pallet.

31. A medium as set forth in claim 25 wherein said computing includes first computing an estimate of said relative degree of ease of integration.

32. A medium as set forth in claim 31 wherein said computing said estimate is computed as a combinatorial algorithm.

33. A medium as set forth in claim 32 wherein said combinatorial algorithm is expressed as 1/V(V−1), wherein V is equal to said number of integration environments.

34. A medium as set forth in claim 31 wherein said computing said estimate is computed as a geometric algorithm.

35. A medium as set forth in claim 34 wherein said geometric algorithm is expressed as e/eˆ (V−1), wherein V is equal to said number of integration environments.

36. A medium as set forth in claim 31 wherein said computing said estimate is computed as an arithmetic algorithm.

37. A medium as set forth in claim 36 wherein said combinatorial algorithm is expressed as 1−((V−1)/maxV), wherein V is equal to said number of integration environments.

38. A medium as set forth in claim 25 wherein said integration coefficient is further a function of said number of integration environments and a number of said modules in each respective one of said number of integration environments.

39. A medium as set forth in claim 25 wherein said integration coefficient is further a function of a proportion of said modules in said other ones of said integration environments to all of said modules in said pallet.

40. A medium as set forth in claim 25 wherein said integration coefficient is further a function of a presence of specific ones of said integration environments and a number of said modules in each respective one of said specific ones of integration environments.

41. A medium as set forth in claim 25 wherein said integration coefficient, W( ), is further a function of selected ones of a first function, f( ), of said number of integration environments and a number of said modules in each respective one of said number of integration environments, a second function, g( ), of a proportion of said modules in said other ones of said integration environments to all of said modules in said pallet, and a third function, h( ), of a presence of specific ones of said integration environments and a number of said modules in each respective one of said specific ones of integration environments.

42. A medium as set forth in claim 41 wherein said first function is expressed as f( )=f(V,∃Pn,Pn, % Pn,P[x], % P[x]).

43. A medium as set forth in claim 41 wherein said second function is expressed as g( )=g(Pn, % Pn).

44. A medium as set forth in claim 41 wherein said third function is expressed as h( )=h(P[xy],P[x], % P[x]).

45. A medium as set forth in claim 25 wherein computing further includes scaling said integration coefficient in the event all of said modules in said pallet are selected from only one of said integration environments.

46. A medium as set forth in claim 45 wherein said scaling includes a scaling factor, M, such that W( )=M*W( ).

47. A medium as set forth in claim 46 wherein said scaling factor is expressed as M=∃(M[x]*% P[x]).

48. A medium as set forth in claim 47 wherein said scaling factor is different for each respective one of said integration environments.
